(19) United States
(12) Patent Application Publication
(10) Pub. No.: US 2004/0229061 A1
(43) Pub. Date: Nov. 18, 2004

(54) Photostimulable phosphor and method for producing photostimulable phosphor

(76) Inventors: Natsuki Kasai, Tokyo (JP); Takehiko Shoji, Tokyo (JP)

Correspondence Address: CANTOR COLBURN, LLP, 55 GRIFFIN ROAD SOUTH, BLOOMFIELD, CT, 06002

(21) Appl. No.: 10/803,813

(22) Filed: Mar. 17, 2004

(30) Foreign Application Priority Data
Mar. 20, 2003 (JP) 2003-077668

(51) Int. Cl. H05B 33/00

(52) U.S. Cl. 428/485

(57) ABSTRACT

A method for producing a photostimulable phosphor represented by a following General Formula (1), includes subjecting phosphor particles in the photostimulable phosphor to a surface treatment by using a fluorine-containing compound after calcining the phosphor particles: General Formula (1), (Ba₁₋ₓ M¹) FBryI_{1-y} X:aM², bLn, cO wherein M¹ is at least one alkaline earth metal atom selected from Mg, Ca, Sr, Zn and Cd; M² is at least one alkaline metal atom selected from Li, Na, K, Rb and Cs; X is at least one halogen atom selected from Cl, Brand I; Ln is at least one rare earth atom selected from Ce, Pr, Sm, Eu, Gd, Tb, Tm, Dy, Ho, Nd, Er and Yb; and x, y, a, b and c are numbers within the range of 0≦x≦0.3, 0≦y≦0.3, 0≦a≦0.05, 0<b≦0.2 and 0<c≦0.1, respectively.

### BACKGROUND OF THE INVENTION

1. Field of the Invention

The present invention relates to a photostimulable phosphor (hereinafter simply referred to as a phosphor), a method for producing the photostimulable phosphor and a radiographic image (hereinafter referred to as a radiographic image) conversion panel. More specifically, the present invention relates to a rare earth activated alkaline earth metal fluorohalide photostimulable phosphor, particularly, exhibiting little deterioration in performance due to moisture absorption, and a method for producing the photostimulable phosphor.

2. Description of Related Art

Radiographic images such as X-ray images are frequently employed in diagnosis of diseases. For obtaining such X-ray images, there has been employed so-called radiography in which X-rays transmitted through an object are irradiated onto a phosphor layer (fluorescent screen), thereby visible light is generated and is irradiated on a film using silver salt in the same manner as in normal photography, and the film is then developed. However, in recent years, methods of directly taking out images from phosphor layer without using a film coated with silver salts have been devised.

As such a technique, there is known a method in which radiation transmitted through an object is allowed to be absorbed by a phosphor, and thereafter this phosphor is excited, for example, by light or heat energy to bring the radiation energy stored by being absorbed as described above to radiate as fluorescence, which fluorescence is detected and formed into an image. Specifically, a radiographic image conversion method using photostimulable phosphors is known, for example, as described in U.S. Pat. No. 3,859,527 and Japanese Patent Application Publication-Tokukaisho-55-12144.

This method employs a radiographic image conversion panel containing a photostimulable phosphor, where a photostimulable phosphor layer of the radiographic image conversion panel is exposed to radiation transmitted through an object to store radiation energies corresponding to the radiation transmission degree of all areas of the object, followed by sequentially exciting the photostimulable phosphor with an electromagnetic wave (excitation light) such as visible light or infrared rays to release the radiation energy stored in the photostimulable phosphor as photostimulated emission, photo-electrically detecting the emitted light to obtain electric signals, and reproducing the radiation image of the object as a visible image from the electrical signals on a recording material such as photographic film or a display apparatus such as a CRT.

The above-described radiation image recording and reproducing method has an advantage in that radiation images having abundant information content can be obtained at an extremely low exposure dose, as compared with conventional radiography using the combination of a conventional radiographic film and intensifying screen.

As described above, the photostimulable phosphor, after being exposed to radiation, exhibits photostimulated emission upon exposure to the excitation light. In practical use, phosphors are generally employed, which exhibit an emission within a wavelength region of 300 to 500 nm excited by excitation light at wavelengths of 400 to 900 nm.

Examples of the photostimulable phosphor conventionally used in the radiographic image conversion panel include,

(1) a rare earth element activated alkaline earth metal fluorohalide phosphor represented by the formula of (Ba_{1-X}, M²⁺x)FX:yA, as described in Japanese Patent Application Publication-Tokukaisho-55-12145, in which M²⁺ is at least one of Mg, Ca, Sr, Zn and Cd; X is at least one of Cl, Br and I; A is at least one of Eu, Tb, Ce, Tm, Dy, Pr, Ho, Nd, Yb, and Er; x and y are numbers meeting the conditions of 0≦x≦0.6 and 0≦y≦0.2; and the phosphor may contain the following additives:

X′, BeX″ and M³X₃′″, as described in Japanese Patent Application Publication-Tokukaisho-56-74175 (in which X′, X″ and X′″ are respectively at least one of Cl, Br and I; and M³ is a trivalent metal);

a metal oxide described in Japanese Patent Application Publication-Tokukaisho-55-160078, such as BeO, BgO, CaO, SrO, BaO, ZnO, Al₂O₃, Y₂O₃, La₂O₃, In₂O₃, SiO₂, TiO₂, ZrO₂, GeO₂, SnO₂, Nb₂O₅, Ta₂O₅ and ThO₂;

Zr and Sc described in Japanese Patent Application Publication-Tokukaisho-56-116777;

B described in Japanese Patent Application Publication-Tokukaisho-57-23673;

As and Si described in Japanese Patent Application Publication-Tokukaisho-57-23675;

M·L (in which M is at least one alkali metal selected from the group consisting of Li, Na, K, Rb and Cs; L is at least one trivalent metal selected from the group consisting of Sc, Y, La, Ce, Pr, Nd, Pm, Sm, Gd, Tb, Dy, Ho, Er, Tm, Yb, Lu, Al, Ga, In, and Tl) described in Japanese Patent Application Publication-Tokukaisho-58-206678;

calcined tetrafluoroboric acid compound described in Japanese Patent Application Publication-Tokukaisho-59-27980;

calcined, univalent or divalent metal salt of hexafluorosilic acid, hexafluorotitanic acid and hexafluorozirconic acid described in Japanese Patent Application Publication-Tokukaisho-59-27289;

NaX′ described in Japanese Patent Application Publication-Tokukaisho-59-56479 (in which X′ is at least one of Cl, Br and I);

a transition metal such as V, Cr, Mn, Fe, Co and Ni, as described in Japanese Patent Application Publication-Tokukaisho-59-56480;

M¹ X′, M′² X″, M³X′″ and A, as described in Japanese Patent Application Publication-Tokukaisho-59-75200 (in which M¹ is at least one alkali metal selected from the group consisting of Li, Na, K, Rb and Cs; M′² is at least one divalent metal selected from the group consisting of Be and Mg; M³ is at least one trivalent metal selected from the group consisting of Al, Ga, In and Tl; A is a metal oxide; X′, X″ and X′″ are respectively at least one halogen selected from the group consisting of F, Cl, Br and I);

M¹ X′ described in Japanese Patent Application Publication-Tokukaisho-60-101173 (in which M¹ is at least one alkali metal selected from the group consisting of Rb and Cs; and X′ is at least one halogen selected from the group consisting of F, Cl, Br and I);

M²′X′₂·M²′X″₂ as described in Japanese Patent Application Publication-Tokukaisho-61-23679 (in which M²′ is at least one alkaline earth metal selected from the group consisting of Ba, Sr and Ca; X′ and X″ are respectively at least one halogen selected from the group consisting of Cl, Br and I, and X′≠X″); and

LnX″₃ described in Japanese Patent Application Publication-Tokugansho-60-106752 (in which Ln is at least one rare earth element selected from the group consisting of Sc, Y, La, Ce, Pr, Nd, Pm, Sm, Gd, Tb, Dy, Ho, Er, Tm, Yb and Lu; X″ is at least one halogen selected from the group consisting of F, Cl, Br and I);

(2) a divalent europium activated alkaline earth metal halide phosphor described in Japanese Patent Application Publication-Tokukaisho-60-84381, represented by the formula of M²X₂·aM²′X′₂:xEu²⁺ (in which M² is at least one alkaline earth metal selected from the group consisting of Ba, Sr and Ca; each of X and X′ is at least one halogen selected from the group consisting of Cl, Br and I and X≠X′; a and x are respectively numbers meeting the requirements of 0.1≦a≦10.0 and 0<x≦0.2);

the phosphor may contain the following additives;

M¹X″ described in Japanese Patent Application Publication-Tokukaisho-60-166379 (in which M¹ is at least one alkali metal selected from the group consisting of Rb, and Cs; X″ is at least one halogen selected from the group consisting of F, Cl, Br and I;

KX″, MgX₂′″ and M³ X₃″″ described in Japanese Patent Application Publication-Tokukaisho-60-221483 (in which M³ is at least one trivalent metal selected from the group consisting of Sc, Y, La, Gd and Lu; each of X″, X′″ and X″″ is at least one halogen selected from the group consisting of F, Cl, Br and I);

B described in Japanese Patent Application Publication-Tokukaisho-60-228592;

an oxide such as SiO₂ or P₂O₅ described in Japanese Patent Application Publication-Tokukaisho-60-228593;

LiX″ and NaX″ described in Japanese Patent Application Publication-Tokukaisho-61-120882 (in which X″ is at least one halogen selected from the group consisting of F, Cl, Br and I);

SiO described in Japanese Patent Application Publication-Tokukaisho-61-120883;

SnX₂″ described in Japanese Patent Application Publication-Tokukaisho-61-120885 (in which X″ is at least one halogen selected from the group consisting of F, Cl, Br and I;

CsX″ and SnX₂′″ described in Japanese Patent Application Publication-Tokukaisho-61-235486 (in which X″ and X′″ are respectively at least one halogen selected from the group consisting of F, Cl, Br and I; and

CsX″ and Ln³⁺ described in Japanese Patent Application Publication-Tokukaisho-61-235487 (in which X″ is at least one halogen selected from the group consisting of F, Cl, Br and I; Ln is at least one rare earth element selected from the group consisting of Sc, Y, Ce, Pr, Nd, Sm, Gd, Tb, Dy, Ho, Er, Tm, Yb and Lu);

(3) a rare earth element activated rare earth oxyhalide phosphor represented by the formula of LnOX:xA, as described in Japanese Patent Application Publication-Tokukaisho-55-12144 (in which Ln is at least one of La, Y, Gd and Lu; X is at least one of Cl, Br and I; A is at least one of Ce and Tb; and x is a number meeting the following condition, 0<x<0.1);

(4) a cerium activated trivalent metal oxyhalide phosphor represented by the formula of M³OX:xCe, as described in Japanese Patent Application Publication-Tokukaisho-58-69281 (in which M³ is at least one metal oxide selected from the group consisting of Pr, Nd, Pm, Sm, Eu, Tb, Dy, Ho, Er, Tm, Yb and Bi; X is at least one of Cl, Br and I; x is a number meeting the following condition, 0<x<0.1);

(5) a bismuth activated alkali metal halide phosphor represented by the formula of M¹X:xBi, as described in Japanese Patent Application Publication-Tokugansho-60-70484 (in which M¹ is at least one alkali metal selected from the group consisting of Rb and Cs; X is at least one halogen selected from the group consisting of Cl, Br and I; x is a number meeting the following condition, 0<x≦0.2);

(6) a divalent europium activated alkaline earth metal halophosphate phosphor represented by the formula of M²₅(PO₄) 3 X:xEu²⁺, as described in Japanese Patent Application Publication-Tokukaisho-60-141783 (in which M² is at least one alkaline earth metal selected from the group consisting of Ca, Sr and Ba; X is at least one halogen selected from the group consisting of F, Cl, Br and I; x is a number meeting the following condition, 0<x≦0.2);

(7) a divalent europium activated alkaline earth metal haloborate phosphor represented by the formula of M²₂BO₃X:xEu²⁺, as described in Japanese Patent Application Publication-Tokukaisho-60-157099 (in which M² is at least one alkaline earth metal selected from the group consisting of Ca, Sr and Ba; X is at least one halogen selected from the group consisting of Cl, Br and I; x is a number meeting the following condition, 0<x≦0.2);

(8) a divalent europium activated alkaline earth metal halophosphate phosphor represented by the formula of M²₂ PO₄ X:xEu²⁺, as described in Japanese Patent Application Publication-Tokukaisho-60-157100 (in which M² is at least one alkaline earth metal selected from the group consisting of Ca, Sr and Ba; X is at least one halogen selected from the group consisting of Cl, Br and I; x is a number meeting the following condition, 0<x≦0.2);

(9) a divalent europium activated alkaline earth metal hydrogenated halide phosphor represented by the formula of M²HX:xEu²⁺, as described in Japanese Patent Application Publication-Tokukaisho-60-217354 (in which M² is at least one alkaline earth metal selected from the group consisting of Ca, Sr and Ba; X is at least one halogen selected from the group consisting of Cl, Br and I; x is a number meeting the following condition, 0<x≦0.2);

(10) a cerium activated rare earth complex halide phosphor represented by the formula of LnX₃·aLn′X₃′:xCe³⁺, as described in Japanese Patent Application Publication-Tokukaisho-61-21173 (in which each of Ln and Ln′ is at least one rare earth element selected from the group consisting of Y, La, Gd and Lu; X and X′ are respectively at least one halogen selected from the group consisting of F, Cl, Br and I and X≠X′; a and x are respectively numbers meeting the following conditions, 0.1<a≦10.0 and 0<x≦0.2)

(11) a cerium activated rare earth complex halide phosphor represented by the formula of LnX₃ aM¹X′:xCe³⁺, as described in Japanese Patent Application Publication-Tokukaisho-61-21182 (in which Ln and Ln′ are respectively at least one rare earth element selected from the group consisting of Y, La, Gd and Lu; M¹ is at least one alkali metal selected from the group consisting of Li, Na, K, Cs and Rb; X and X′ are respectively at least one halogen selected from the group consisting of Cl, Br and I; a and x are respectively numbers meeting the following conditions, 0<a≦10.0 and 0<x≦0.2;

(12) a cerium activated rare earth halophosphate phosphor represented by the formula of LnPO₄·aLnX₃:xCe³⁺, as described in Japanese Patent Application Publication-Tokukaisho-61-40390 (in which Ln is at least one rare earth element selected from the group consisting of Y, La, Gd and Lu; X is at least one halogen selected from the group consisting of F, Cl, Br and I; a and x are respectively numbers meeting the following conditions, 0.1≦a≦10.0 and 0<x≦0.2;

(13) a divalent europium activated cesium rubidium halide 2+phosphor represented by the formula of CsX:aRbX′:xEu²⁺, as described in Japanese Patent Application Publication-Tokugansho-60-78151 (in which X and X′ are respectively at least one halogen selected from the group consisting of Cl, Brand I; a and x are respectively numbers meeting the following conditions, 0<a≦10.0 and 0<x≦0.2); and

(14) a divalent europium activated complex halide phosphor represented by the formula of M²X₂·aM¹X′:xEu²⁺, as described in Japanese Patent Application Publication-Tokugansho-60-78153 (in which M² is at least one alkaline earth metal selected from the group consisting of Ba, Sr and Ca; M¹ is at least one alkali metal selected from the group consisting of Li, Rb and Cs; X and X′ are respectively at least one halogen selected from the group consisting of Cl, Br and I; a and x are respectively numbers meeting the following conditions, 0.1≦a≦20.0 and 0<x≦0.2.

Of the above-described photostimulable phosphors, an iodide-containing divalent europium activated alkaline earth metal fluorohalide phosphor, iodide-containing divalent europium activated alkaline earth metal halide phosphor, iodide-containing rare earth element activated rare earth oxyhalide phosphor and iodide-containing bismuth activated alkali metal halide phosphor exhibit photostimulated emission having high luminance.

Radiographic image conversion panels using these photostimulable phosphors, after storing radiation image information, release stored energy by scanning with excitation light so that after scanning, radiation images can be again stored and the panel can be used repeatedly. In conventional radiography, a radiographic film is consumed for each photographing exposure; in the radiographic image conversion method, however, the radiographic image conversion panel is repeatedly used, which is advantageous in terms of natural resource conservation and economic efficiency.

It is therefore desirable to provide performance capable of withstanding for the use over a long period of time, without deteriorating quality of radiation image obtained, to the radiographic image conversion panel.

However, in general, photostimulable phosphors used in the production of the radiographic image conversion panel are so hygroscopic that when allowed to stand in a room under usual climatic conditions, the phosphor absorbs atmospheric moisture and is remarkably deteriorated over an elapse of time.

Specifically, when the photostimulable phosphor is allowed to stand under high humidity, radiation sensitivity of the phosphor is lowered along with an increase in absorbed moisture content. In general, radiation latent images recorded onto the photostimulable phosphor, after being exposed to radiation, regress over an elapse of time and therefore, as the period between exposure to radiation and the scanning with excitation light requires longer time, the intensity of reproduced radiation image signal becomes less, so that moisture absorption of the photostimulable phosphor accelerates the above-described latent image regression.

Accordingly, the use of a radiographic image conversion panel having such a moisture-absorbing photostimulable phosphor lowers reproducibility of reproduced signals at the time of reading radiation images.

It is generally known that stimulability of photostimulable phosphor particles depends on their particle sizes and Japanese Patent Application Publication-Tokukaisho-55-163500 describes that the preferred average particle size is 1 to 30 μm. The relationship between the average phosphor particle size and characteristics such as sensitivity, graininess and sharpness is disclosed in Japanese Patent Application Publication-Tokukouhei-3-79680.

An attempt to control the size and form of these photostimulable phosphor particles in the liquid phase process is disclosed in Japanese Patent Application Publication-Tokukaihei-7-233369. In the production of rare earth activated alkaline earth metal fluorohalide photostimulable phosphors, the conventional method is that raw material compounds such as an alkaline earth metal fluoride, an alkaline earth metal halide other than the fluoride, a rare earth element halide and an ammonium fluoride are mixed in a dry process or suspended in an aqueous medium, thereafter, the mixture is calcined and ground. On the contrary, there is disclosed a process, in which a rare earth activated alkaline earth metal fluorohalide photostimulable phosphor is precipitated in an aqueous solution.

The above-described liquid phase process, in which a rare earth activated alkaline earth metal fluorohalide photostimulable phosphor is precipitated in an aqueous solution, enables to obtain phosphor particles of small and homogeneous particle size with no deterioration in performance due to grinding.

However, enhancing sensitivity or rendering particles smaller produces more serious problems such as deterioration due to moisture than in the past. The deterioration is initiated at the moment when the phosphor particles, after calcination, are exposed to the atmosphere and to prevent such a deterioration, storage of calcined phosphor particles under an environment screened from the atmosphere has been contemplated but it is essentially difficult to conduct the whole process of preparing a phosphor plate under such an environment.

To prevent the above-described deterioration in performance of photostimulable phosphor particles due to moisture absorption, there have been heretofore proposed a method by the use of a titanate-type coupling agent (see, e.g., Japanese Patent Application Publication-Tokukouhei-2-278196) and a method by the use of silicone oil (see, e.g., Japanese Patent Application Publication-Tokukouhei-5-52919). However, none of these proposals led to fundamental solution.

### SUMMARY OF THE INVENTION

An object of the present invention is to provide a photostimulable phosphor used for obtaining a radiographic image conversion panel which exhibits little deterioration in performance due to moisture absorption, is usable in a viable state over a long period of time and has excellent effects on image properties, and to provide a method for producing the photostimulable phosphor.

In order to accomplish the above object, in accordance with a first aspect of the invention, a method for producing a photostimulable phosphor represented by a following General Formula (1), comprises: subjecting phosphor particles in the photostimulable phosphor to a surface treatment by using a fluorine-containing compound after calcining the phosphor particles:

(Ba₁₋ₓM¹)FBryI_{1-y}X:aM², bLn, cO General Formula (1)

wherein M¹ is at least one alkaline earth metal atom selected from Mg, Ca, Sr, Zn and Cd; M² is at least one alkaline metal atom selected from Li, Na, K, Rb and Cs; X is at least one halogen atom selected from Cl, Br and I; Ln is at least one rare earth atom selected from Ce, Pr, Sm, Eu, Gd, Tb, Tm, Dy, Ho, Nd, Er and Yb; and x, y, a, b and c are numbers within the range of 0≦x≦0.3, 0≦y≦0.3, 0≦a≦0.05, 0<b≦0.2 and 0<c≦0.1, respectively.

In particular, the photostimulable phosphor of the invention is preferably produced in a liquid phase process.

In accordance with a second aspect of the invention, a photostimulable phosphor is produced by subjecting phosphor particles in the photostimulable phosphor represented by a following General Formula (1) to a surface treatment by using a fluorine-containing compound after calcining the phosphor particles:

(Ba₁₋ₓM¹)FBryI_{1-y}X:aM², bLn, cO General Formula (1)

wherein M¹ is at least one alkaline earth metal atom selected from Mg, Ca, Sr, Zn and Cd; M² is at least one alkaline metal atom selected from Li, Na, K, Rb and Cs; X is at least one halogen atom selected from Cl, Br and I; Ln is at least one rare earth atom selected from Ce, Pr, Sm, Eu, Gd, Tb, Tm, Dy, Ho, Nd, Er and Yb; and x, y, a, b and c are numbers within the range of 0≦x≦0.3, 0≦y≦0.3, 0≦a≦0.05, 0<b≦0.2 and 0<c≦0.1, respectively.

In the first and second aspects of the invention, it is preferable that the fluorine-containing compound is obtained from a coating composition prepared by dissolving a fluorine-containing polymer with a fluorinated solvent.

In particular, it is preferable that the amount of the fluorine-containing compound is from 0.2 to 20% by mass based on the photostimulable phosphor.

### DETAILED DESCRIPTION OF THE INVENTION

The present invention is described in more detail.

As a result of various studies, the inventors have found that deterioration in performance due to moisture absorption of the photostimulable phosphor is caused by deliquescence of the phosphor due to moisture absorption and alteration of the phosphor. However, the present inventors have further found that for preventing deterioration in sensitivity, even if only either one of deliquescence and alteration is prevented, fundamental solution can not be achieved, and both of the deliquescence due to moisture absorption and alteration of the phosphor must be prevented.

The deliquescence refers to phenomenon in which phosphor particles absorb moisture from ambient air to form an aqueous solution by themselves, and the alteration refers to phenomena in which deliquescence is not caused but fluorescence characteristics of the phosphor itself are altered by moisture present in the air. Mechanism of the alteration is not clearly elucidated but the alteration is supposed to be concerned with discoloration in the interior of the phosphor particle.

The construction of the present invention is effective for preventing both deliquescence and alteration. That is, objects of the present invention reside in prevention of deliquescence or alteration of the phosphor due to moisture absorption.

The moisture absorption of the phosphor is assumed to occur due to various causes including capillary condensation and once water vapor is condensed as water drops between phosphor particles, causing deliquescence and leading to deterioration in performance.

It is presumed that surface treatment of the phosphor particles using a fluorine-containing compound is effective for preventing occurrence of deliquescence as described above. Particularly, when using a fluorine-containing compound hydrophobized, effects of the present invention can be obtained.

Further, in order to mix an appropriate amount of a fluorine-containing compound with phosphor particles having an average particle size of a few μm to scores of μm, any method known in the art is usable. However, in terms of uniform coating of phosphor particles, preferred is a method in which phosphor particles are gradually added to a liquid having dissolved therein the fluorine-containing compound, followed by mixing using a mixing apparatus such as Turbla Shaker Mixer (manufactured by Shinmaru Enterprises Co.).

In the present invention, the amount of the fluorine-containing compound is preferably from 0.2 to 20% by mass based on the phosphor. If it exceeds 20% by mass, reduction of sensitivity is caused, whereas if it is less than 0.2% by mass, effects of the present invention cannot be provided.

The present invention is characterized in that the photostimulable phosphor particle represented by the General Formula (1) is surface treated with a fluorine-containing compound.

In the present invention, the following fluorine-containing compounds are preferred.

The fluorine-containing polymer preferably used in the present invention is a compound in which a fluoroaliphatic group-containing unsaturated ester monomer for a copolymer contains an aliphatic group at least partially substituted by fluorine, particularly, an alkyl group at least partially substituted by fluorine, and has a polymerizable ethylenically unsaturated carbon-carbon double bond. Specific examples of the fluoroaliphatic group-containing unsaturated ester monomer include the following compounds:

Rf-Q-O—C(═O)—C(R₁)═CH₂

wherein Rf is a linear, branched or cyclic aliphatic group at least partially fluorinated and having 2 to 12 carbon atoms, for example, an alkyl group at least partially fluorinated, preferably an alkyl group wholly fluorinated; R₁ is a hydrogen atom or CH₃; Q is a lower alkylene group, for example, —CH₂—, —CH₂CH₂— or —SO₂NR₂-a lower alkylene group such as —SO₂NR₂—CH₂— or —SO₂NR₂—CH₂CH₂—; and R₂ is a hydrogen atom or a lower alkyl group, for example, —CH₃ or —C₂H₅.

Rf is preferably a C₃-C₇ fluoroaliphatic group, particularly preferably a C₃-C₆ fluoroaliphatic group.

A terminal group of Rf is preferably a wholly fluorinated —CF₃ group in terms of more exerting effects of the present invention. Q is a lower alkylene group, preferably —CH₂— or —CH₂CH₂—

Specific examples thereof include F(CF₂)₆CH₂OC(═O)C(CH₃)═CH₂, C₇F₁₅—SO₂N(C₂H₅)C₂H₄OC(═O)C(CH₃)═CH₂, c-C₆F₁₁CH₂OC(═O)C(CH₃)═CH₂, C₆F₁₃C₂H₄OC(═O)CH═CH₂, (CF₃)₂CF(CF₂)₂C₂H₄OC(═O)CH═CH₂, H(CF₂)₄CH₂OC(═O)CH═CH₂, F(CF₂)₄C₂H₄OC(═O)CH═CH₂ and F(CF₂)₃CH₂OC(═O)CH═CH₂. These monomers can be produced by a conventional method as described in U.S. Pat. No. 2,803,615 and U.S. Pat. No. 2,841,573.

Further, a polymer obtained by subjecting a perfluoroether having two terminal double bonds to radical polymerization independently or in combination with other radical copolymerizable monomers is given.

Such polymers are disclosed, for examples, in Japanese Patent Application Publication-Tokukaisho-63-238111 and Japanese Patent Application Publication-Tokukaisho-63-238115.

More specifically, a perfluoroether having two terminal double bonds, for example, CF₂═CF(CF₂)n-O—(CF₂)mCF═CF₂ (wherein n is 0 to 5, m is 0 to 5 and m+n is 1 to 6) is subjected to radical polymerization independently or in combination with other radical copolymerizable monomers, and further subjected to cyclic polymerization to obtain a fluorine-containing polymer. For example, by subjecting CF₂═CF—O—(CF₂)CF═CF₂ to radical polymerization, there is obtained a fluorine-containing polymer having a 5-membered cyclic structure in a main chain as described below:

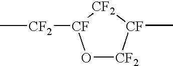

Examples of other monomers radical-polymerizable with the perfluoroether having two terminal double bonds include fluoroolefin such as tetrafluoroethylene; fluorovinylether such as perfluorovinylether; fluorinated vinylidene; fluorinated vinyl; and chlorotriethylene.

Examples of the fluorine-containing polymer further include one disclosed in Japanese Patent Application Publication-Tokukousho-63-18964.

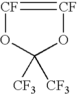

Specific examples thereof include an amorphous copolymer having a monomer unit of perfluoro-2,2-dimethyl-1,3-dioxole (PDD) and a monomer unit of tetrafluoroethylene as described above, or an amorphous terpolymer having other monomer unit of ethylenically unsaturated monomer in addition to the above-described monomer units.

As the ethylenically unsaturated monomer for a terpolymer, for example, olefins such as ethylene and 1-butene; vinyl compounds such as vinyl fluoride and vinylidene fluoride; and perfluoro compounds such as perfluoropropene can be used.

As commercially available fluorine-containing polymers, Cytop CTX-805 and CTX109A (trade name) manufactured by Asahi Glass Co., Ltd. are also preferably used.

Examples of a solvent for the fluorine-containing polymers include ethers containing a hydrogen atom and a fluorine atom, namely, a hydrofluoroether (HFE). Useful hydrofluoroethers include the following two ethers:

(1) a separation-type hydrofluoroether in which an ether-bonded alkyl or alkylene segment in HFE is perfluorinated (e.g., a perfluorocarbon group), or is not fluorinated (e.g., a hydrocarbon group) and therefore, is not partially fluorinated; and

(2) an ω-hydrofluoroalkylether in which an ether-bonded segment is not fluorinated (e.g., a hydrocarbon group), is perfluorinated (e.g., a perfluorocarbonether group), or is partially fluorinated (e.g., a fluorocarbon or hydrofluorocarbon group).

The separation-type hydrofluorocarbonether includes a hydrofluoroether containing at least one of mono-, di- or trialkoxy substituted perfluoroalkane, perfluorocycloalkane, perfluorocycloalkyl-containing perfluoroalkane or perfluorocycroalkylene-containing perfluoroalkane compounds. These HFEs are described, for example, in WO96/22356, and preferred is a compound represented by the following Formula 1:

Rf-(O—Rh)x Formula 1

in Formula 1, x is 1 to 3, preferably 1, Rf is a perfluorinated linear, branched or cyclic hydrocarbon group having a valence of x and having 6 to 15 carbon atoms, Rf may contain one or more hetero atom existing in a chain, Rf may contain an F₅S-group at a terminal in all cases, Rhs each independently is a linear or branched alkyl group having 1 to 3 carbon atoms, preferably having 1 or 2 carbon atoms, more preferably a methyl group. Among the above-described HFEs, preferred is one in which Rf does not contain a hetero atom and does not contain a F₅S-group at the terminal.

Representative examples of the hydrofluoroether compounds represented by Formula 1 include the following compounds:

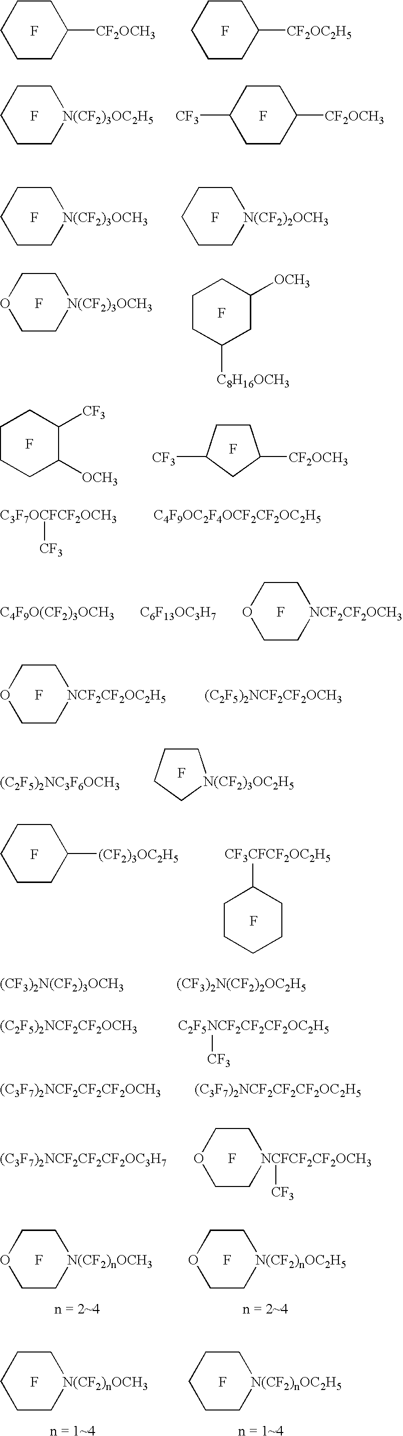

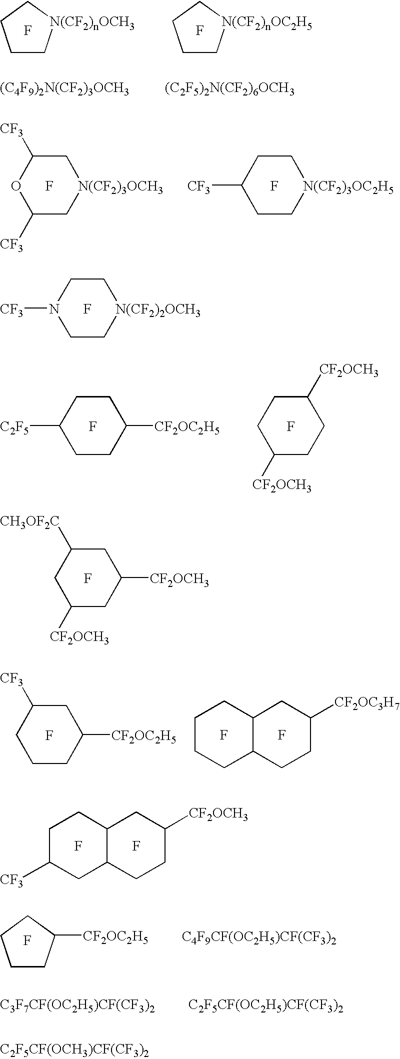

In the above-described compounds, a cyclic structure represented by “F” is perfluorinated. These HFE compounds may be used alone or as a mixture with another HFE.

As other useful hydrofluoroethers, an ω-hydrofluoroalkylether described by a general structure represented by the following Formula 2 can also be preferably used.

X—Rf′-(O-Rf″)y-O—R″—H

In the above-described compound, X is a fluorine atom or a hydrogen atom, Rf′ is a bivalent perfluorinated organic group having 1 to 12 carbon atoms, Rf″ is a bivalent perfluorinated organic group having 1 to 6 carbon atoms, R″ is a bivalent organic group having 1 to 6 carbon atoms, and preferably perfluorinated, y is an integer of 0 to 4, and when x is a fluorine atom and y is 0, R″ contains at least one F atom, provided that the total number of fluorinated carbon atoms is at least 6.

Representative examples of the compound represented by Formula 2 include:

C₄F₉OC₂F₄H

HC₃F₆OC₃F₆H

C₅F₁₁OC₂F₄H

C₆F₁₃OCF₂H

C₆F₁₃OC₂HF₄

c-C₆F₁₁CF₂OC₂F₄H

HCF₂O(C₂F₄O)n(CF₂O)CF₂H

C₃F₇O{C(CF₃)CF₂O}pCFHCF₃

C₄F₈OCF₂C(CF₃)₂CF₂H

HCF₂CF₂OCF₂C(CF₃)₂CF₂OC₂F₄H

C₇F₁₇OCFHCF₃

C₈F₁₀OCF₂O(CF₂)₅H and

C₈F₁₀OC₂F₄OC₂F₄OCF₂H.

A solvent particularly useful for the coating composition and coating method of the present invention has Rf′″-OC₂H₅ (Rf′″ is a linear or branched perfluoroalkyl group having 6 to 15 carbon atoms). Rf′″ is most preferably 3-ethoxyperfluoro(2-methylhexane) (e.g., CF₃CF(CF₃)CF(OC₂H₅)C₃F₇) having 6 to 8 carbon atoms.

These solvents have a solvent property equal to that of a conventional PFC solvent. Specifically, 3-ethoxy perfluoro(2-methylhexane) has a surface tension and a viscosity (25° C.), which act as factors determining ability to form a uniform thin film, of 1.4×10⁻²N/m and 1.2×10⁻³ Pa·s, respectively, and has a high solubility equal to that of the PFC with respect to a fluorine-containing polymer.

The coating composition is easily prepared by adding the fluorine-containing polymer having the cyclic structure in the hydrofluoroether (HFE) at a room temperature (e.g., 25° C.), followed by stirring.

The solution concentration of the fluorine-containing polymer composition is usually 1 to 20% by mass, though it varies depending on the kind of the fluorine-containing polymer.

According to the coating method of the present invention, by virtue of excellent solvent properties of HFE (e.g., CF₃CF(CF₃)CF(OC₂H₅)C₃F₇), uniform surface treatment can be attained even in such thin surface treatment.

The photostimulable phosphor represented by the General Formula (1) of the present invention is described.

In the General Formula (1), M¹ is at least one alkaline earth metal atom selected from the group consisting of Mg, Ca, Sr, Zn and Cd; M² is at least one alkaline metal atom selected from the group consisting of Li, Na, K, Rb and Cs; X is at least one halogen atom selected from the group consisting of Cl, Br and I; Ln is at least one rare earth element selected from the group consisting of Ce, Pr, Sm, Eu, Gd, Tb, Tm, Dy, Ho, Nd, Er and Yb; and x, y, a, b and c are numbers within the range of 0≦x≦0.3, 0≦y≦0.3, 0≦a≦0.05, 0<b≦0.2 and 0<c≦0.1, respectively.

The photostimulable phosphor particles of the present invention may take any form, including tabular particles, spherical particles, hexagonal particles and tetradecahedral particles.

In the present invention, a photostimulable phosphor precursor produced by a liquid phase synthesis is preferably used. In the liquid phase synthesis, when a super saturation degree in the reaction solution system is controlled, the form and particle size of the photostimulable phosphor precursor can be relatively easily controlled for the production. For example, Japanese Patent Application Publication-Tokukaihei-7-233369 discloses a tetradecahedral photostimulable phosphor and a production method thereof according to the liquid phase process. The tabular particles with a high aspect ratio in the present invention are also preferably prepared using the liquid phase synthesis.

The production method of a photostimulable phosphor precursor described in Japanese Patent Application Publication-Tokuganhei-8-265525 and the apparatus for producing a phosphor precursor described in Japanese Patent Application Publication-Tokuganhei-8-266718 are preferably applicable to producing a photostimulable phosphor precursor by a liquid phase process.

In the present invention, the photostimulable phosphor precursor refers to the state where a material represented by the General Formula (1) has not yet been subjected to a temperature of 600° C. or more (it has not yet been subjected to calcination) and the photostimulable phosphor precursor substantially emits neither photostimulated emission nor instantaneous emission.

In this invention, the photostimulable phosphor precursor is preferably prepared by the following liquid phase synthesis.

(Precursor Production Method)

The method comprises the steps of:

preparing an aqueous mother liquor containing 1.6 mol/l BaI₂, preferably 3.5 mol/l BaI₂ and a halide of Ln, provided that when “a” of General Formula (1) is not zero, the mother liquor further contains a halide of M¹;

adding an aqueous solution containing a 6 mol/l or more inorganic fluoride, preferably a 8 mol/l or more inorganic fluoride (ammonium fluoride or alkaline metal fluoride) into the mother liquor, while maintaining the mother liquor at 50° C. or more, preferably 80° C. or more to form a crystalline precipitate of a precursor of the photostimulable phosphor; and

separating the crystalline precipitate of the precursor from the mother liquor.

The photostimulable phosphor precursor exerts photostimulated emission and instantaneous emission only by passing through a calcination step. The photostimulable phosphor is preferably produced from the phosphor precursor according to the calcining process as described below.

(Calcining Process)

The process comprises the steps of:

heating the photostimulable phosphor precursor to a temperature of not less than 600° C. while exposing the photostimulable phosphor precursor to a weakly reducing atmosphere containing less than 100 ppm of oxygen,

introducing oxygen into the reducing atmosphere so that oxygen is at least 100 ppm and the percentage by volume of oxygen is less than that of a reducing component, based on the total volume of the atmosphere, and holding the photostimulable phosphor precursor therein for a period of at least 1 min., while maintaining a temperature of not less than 600° C. after the above-described step, and

turning back the atmosphere and holding the photostimulable phosphor precursor in a weakly reducing atmosphere containing less than 1000 ppm (preferably less than 100 ppm) of oxygen for a period of at least 30 min., while maintaining a temperature at not less than 600° C. after the above-described step, and thereafter cooling the photostimulable phosphor precursor to a temperature of not more than 100° C., while maintaining a weakly reducing atmosphere containing less than 1000 ppm (preferably less than 100 ppm) of oxygen.

The production method of a photostimulable phosphor of the present invention is described in detail below.

(Preparation of Precipitate of Precursor Crystals)

Initially, starting material compounds except for a fluoride compound are dissolved in an aqueous medium. Thus, BaX₂ (BaBr₂, BaI₂) and a halide of Ln and if necessary, a halide of M² and a halide of M¹ are each added into an aqueous medium and dissolved with sufficiently stirring to prepare an aqueous solution, provided that the ratio of BaX₂ (BaBr₂, BaI₂) to the aqueous medium is so pre-adjusted that the BaX₂ concentration is 0.25 mol/l or more. In this case, a small amount of an acid, an inorganic halide (ammonium salt, potassium salt, sodium salt or the like), ammonia, an alcohol, a water-soluble polymer or a fine powdery water-insoluble metal oxide may be optionally added thereto. The aqueous solution (reaction mother liquor) is maintained at 50° C. or more.

Next, into the aqueous solution (reaction mother liquor) maintained at 50° C. or more with stirring, an aqueous solution of an inorganic fluoride (such as ammonium fluoride or alkali metal fluoride) is introduced through a pipe provided with a pump. The aqueous solution is preferably introduced to a portion in which stirring is vigorously performed. Introduction of the inorganic fluoride aqueous solution into the reaction mother liquor results in precipitation of precursor crystals of the phosphor represented by the General Formula (1).

Next, the resulting crystals of the phosphor precursor are separated from the solution through filtration or centrifugation, washed sufficiently with methanol and then dried. To the dried crystals of the phosphor precursor is added an anti-sintering agent such as fine alumina powder or fine silica powder, followed by stirring to allow the anti-sintering agent to uniformly adhere to the surface of the crystals. It is possible to save addition of the anti-sintering agent by selecting the calcination conditions.

(Calcination of Precursor Crystals)

The phosphor precursor crystalline powder is charged into a heat-resistant vessel such as a silica port, an alumina crucible or a silica crucible and then placed in the core portion of an electric furnace to be calcined, without causing the crystals to sinter. The furnace core of the electric furnace is limited to those in which the atmosphere is replaceable during calcination. Preferably employed as the furnace is a moving bed type electric furnace, such as a rotary kiln.

After charging the photostimulable phosphor precursor into the furnace core, the atmosphere in the furnace core is replaced by a weakly reducing atmosphere not containing not less than 1000 ppm (preferably not less than 100 ppm) of oxygen. The weakly reducing atmosphere is preferably a hydrogen/nitrogen mixed gas having a hydrogen concentration of 5% or less, more preferably having a hydrogen concentration of from 0.1 to 3%. When the hydrogen concentration is 0.1% or more, the reducing power is obtained, leading to enhance emission characteristics, while when the hydrogen concentration is 5% or less, it is preferred in view of handling, preventing crystals themselves of the photostimulable phosphor from being reduced.

In this case, prior to atmosphere replacement, the atmosphere in the core maybe evacuated. For the suction to create vacuum, a rotary evacuation pump can be used. The evacuation advantageously improves atmosphere-replacing efficiency. In cases when replacing the atmosphere without evacuation, so-called forced replacement, it is necessary to introduce an atmosphere of at least 3 times the core volume.

After replacing the atmosphere inside of the furnace core with the mixed atmosphere described above, it is heated to at least 600° C. Heating to at least 600° C. is preferable to obtain superior emission characteristics. During the period of from the start of heating to taking-out the photostimulable phosphor, the mixed atmosphere in the furnace core is preferably allowed to flow at a flow rate of at least 0.1 lit./min.

Thereby, the atmosphere in the core is replaced so that reaction products other than the photostimulable phosphor produced in the core can be removed.

Specifically, since the reaction products of the present invention contain an iodide, yellowing of the photostimulable phosphor due to the iodide and deterioration of the photostimulable phosphor due to yellowing can be prevented.

The mixed atmosphere in the furnace core is more preferably allowed to flow at a flow rate of 1.0 to 5.0 lit./min. Further, the heating rate is preferably from 1 to 50° C./min, though it varies depending on the material of the core pipe, the charged amount of precursor crystals and specification of the electric furnace.

After reaching 600° C. or more, oxygen is introduced into the atmosphere, in which the percentage by volume of the oxygen is less than that of a reducing component, based on the total volume of the atmosphere and the atmosphere is further maintained for a period of at least 1 min., in which the temperature is preferably from 600 to 1300° C., more preferably from 700 to 1000° C. At a temperature of 600° C. or more, superior photostimulated emission characteristics can be achieved, and at a temperature of 700° C. or more can be obtained preferred photostimulated emission characteristics for practical radiographic diagnosis. Further, at a temperature of 1300° C. or less can be prevented larger particle formation due to sintering, and specifically at a temperature of 1000° C. or less can be obtained a photostimulable phosphor with preferred particle size for practical radiographic diagnosis. More preferably the temperature is in the vicinity of 820° C.

In this case, the atmosphere replacement is performed under forced replacement, and the weakly reducing atmosphere newly introduced is preferably a mixed gas comprised of not more than 5% of hydrogen, oxygen less than the hydrogen and nitrogen as the remainder. More preferably, the mixed gas is composed of 0.1 to 3% hydrogen, oxygen with a concentration of 40 to 80% of the hydrogen and nitrogen as the remainder. Still more preferably, the mixed gas is composed of 1% of hydrogen, 0.6% of oxygen and the remainder of nitrogen.

At a hydrogen concentration of not less than 0.1% is obtained the reducing power, leading to enhance emission characteristics. Further, the hydrogen concentration of not more than 5% is preferred in terms of handling, preventing crystals themselves of the photostimulable phosphor from being reduced. Furthermore, at an oxygen peak concentration of about 60% of the hydrogen concentration, the photostimulated emission intensity is markedly enhanced.

In this case, oxygen may be introduced into the furnace core atmosphere during heating, wherein the mixing ratio of the atmosphere can be adjusted by the ratio of the flow rate of a hydrogen/nitrogen mixed gas to that of oxygen. In place of oxygen, an atmosphere may be introduced as it is. Furthermore, the ratio of the flow rate of an oxygen/nitrogen mixed gas to that of a hydrogen/nitrogen mixed gas may be adjusted.

Until reaching the desired mixing ratio of nitrogen, hydrogen and oxygen, a new atmosphere of at least 3 times the volume of the furnace core must be introduced. Further for at least 1 min., and preferably for 1 to 60 min., the mixed atmosphere of nitrogen, hydrogen and oxygen is maintained at a temperature of not less than 600° C.

After completing the procedure described above, the atmosphere in the furnace core is again replaced by a weakly reducing atmosphere. To expel all oxygen remaining in the core to levels of less than 1000 ppm (preferably less than 100 ppm), a weakly reducing gas used in the heating step is preferably employed. To enhance efficiency of replacement, the flow rate of the weakly reducing gas may be temporarily increased. When the weakly reducing gas is newly introduced in an amount of 10 times the volume of the furnace core, oxygen is expelled to levels of less than 1000 ppm (preferably less than 100 ppm). The weakly reducing atmosphere containing less than 1000 ppm (preferably 100 ppm) of oxygen is further maintained at a temperature of 600° C. or more for a period of at least 30 min. and preferably for 30 min. to 12 hrs.

“At least 30 min.” results in a photostimulable phosphor exhibiting superior photostimulated emission characteristics, and “not more than 12 hrs.” leads to prevention of deterioration in photostimulated emission characteristics due to overheating. Cooling is conducted in a manner similar to the heating step.

The desired oxygen-introduced rare earth activated alkaline earth metal fluorohalide photostimulable phosphor can be obtained according to the calcination described above.

(Surface Treatment by Fluorine-Containing Compound)

As a result of various studies, the inventors have found that a fluorine-containing compound was effective in preventing discoloration of photostimulable phosphors and specifically, it was effective in preventing reduction of sensitivity due to coloration of the photostimulable phosphor.

When the phosphor contains an iodine atom, the discoloration of the photostimulable phosphor becomes marked. The reason thereof has not been clarified and it is assumed that the fluorine-containing compound can prevent yellowing of the phosphor due to liberated iodide.

To allow the coating agent prepared by dissolving the fluorine polymer with a fluorinated solvent to be adhered onto phosphor particles, any method known in the art is usable.

Examples thereof include a method in which a fluorine polymer-containing coating agent is dropwise added or sprayed to phosphor particles with stirring by use of Henschel mixer; a slurry method in which a fluorine polymer-containing coating agent is dropwise added to phosphor particles in the form of slurry with stirring, and after completing addition, the phosphor is precipitated, filtered and dried to remove a residual solvent; a method in which after dispersing a phosphor in a solvent and adding thereto a fluorine polymer-containing coating agent with stirring, the solvent is evaporated; and a surface treatment in which a fluorine polymer-containing coating agent is added to a photostimulable phosphor-dispersion solution with stirring.

In order to ensure the reaction with the phosphor as to drying for the fluorine polymer-containing coating agent, surface treatment is conducted preferably at 40 to 160° C. over a period of 10 to 200 min.

Examples of such a surface treatment of the phosphor particles include a method in which phosphor particles immediately after being calcined are ground in a dispersion solution comprising a fluorine polymer-containing coating agent to be subjected to surface treatment using the fluorine polymer-containing coating agent, followed by being filtered and dried; and a method in which photostimulable phosphors and a fluorine polymer-containing coating agent are together added to a phosphor coating solution.

In the present invention, the fluorine polymer is preferably used in an amount of 20% or less, more preferably 0.2 to 2%.

(Preparation of Radiographic Image Conversion Panel)

As supports used in the radiographic image conversion panel according to the present invention are employed various types of polymeric material, glass and metals. Materials which can be converted to a flexible sheet or web are particularly preferred in handling as an information recording material. From this point, there are preferred plastic films such as cellulose acetate films, polyester films, polyethylene terephthalate films, polyamide films, polyimide films, triacetate films or polycarbonate films; metal sheets such as aluminum, iron, copper or chromium; or metal sheets having the metal oxide covering layer.

A thickness of the support varies depending on materials of the support, and is generally 80 to 1000 μm and preferably 80 to 500 μm in terms of handling.

The surface of the supports may be smooth or may be matte for the purpose of enhancing adhesiveness to a photostimulable phosphor layer. Further, the support may be provided with a subbing layer under the photostimulable phosphor layer for the purpose of enhancing adhesiveness to the photostimulable phosphor layer.

Representative examples of binders used in the photostimulable phosphor layer include proteins such as gelatin, polysaccharide such as dextran, natural polymeric materials such as gum arabic and synthetic polymeric materials such as polyvinyl butyral, polyvinyl acetate, nitrocellulose, ethylcellulose, vinylidene chloride/vinyl chloride copolymer, polyalkyl (meth)acrylate, vinyl chloride/vinylacetate copolymer, polyurethane, cellulose acetate butyrate, polyvinyl alcohol and linear polyester. Of these binders are preferred nitrocellulose, linear polyester, polyalkyl (meth)acrylate, a mixture of nitrocellulose and linear polyester, a mixture of nitrocellulose and polyalkyl (meth)acrylate and a mixture of polyurethane and polyvinyl butyral. The binders may be cured with a cross-linking agent.

The photostimulable phosphor layer can be coated on a subbing layer, for example, according to the following manner.

Thus, the iodide-containing photostimulable phosphor of the present invention, a compound such as a phosphite ester for preventing yellow stain of the phosphor and a binder are added into an optimal solvent, followed by sufficiently mixing to prepare a coating solution in which phosphor particles and particles of the compound are uniformly dispersed in a binder solution.

The binder is generally employed in an amount of 0.01 to 1 part by mass per 1 part by mass of the photostimulable phosphor. However, a smaller amount of the binder is preferred in terms of sensitivity and sharpness of the obtained radiographic image conversion panel and a range of 0.03 to 0.2 part by mass is preferred in terms of easiness of coating.

A mixing ratio of the binder to the photostimulable phosphor (with the proviso that in the case of all of the binder being an epoxy group-containing compound, the ratio is equal to that of the compound to the phosphor) in the coating solution varies depending on characteristics of the objective radiographic image conversion panel, the kind of the phosphor and an added amount of the epoxy group-containing compound. Examples of solvents used for preparing the coating solution include lower alcohols such as methanol, ethanol, 1-propanol, 2-propanol, and butanol; chlorine atom-containing hydrocarbons such as methylene chloride and ethylene chloride; ketones such as acetone, methyl ethyl ketone and methyl isobutyl ketone; esters of a lower fatty acid and lower alcohol such as methyl acetate, ethyl acetate and butyl acetate; ethers such as dioxane, ethylene glycol ethyl ether and ethylene glycol monomethyl ether; toluene; and a mixture thereof.

There may be incorporated, in the coating solution, a dispersing agent such as stearic acid, phthalic acid, caproic acid and oleophilic surfactants for the purpose of improving dispersibility of the phosphor particles in the coating solution. A plasticizer may be optionally incorporated for the binder. Examples of such a plasticizer include phthalate esters such as diethyl phthalate and dibutyl phthalate; aliphatic dibasic acid esters such as diisodecyl succinate and dioctyl adipinate; and glycolic acid esters such as ethylphthalylethyl glycolate and butylphthalylbutyl glycolate.

The coating solution as prepared above is uniformly coated on the surface of the subbing layer to form a coating layer. Coating can be carried out by conventional coating means, such as doctor blade, roll coater and knife coater. Subsequently, the formed coating layer is gradually heated and dried to complete formation of the photostimulable phosphor layer on the subbing layer.

The coating solution of the photostimulable phosphor layer can be prepared by using a dispersing apparatus, such as a ball mill, sand mill, attritor, three-roll mill, high-speed impeller, Kady mill and ultrasonic homogenizer. The prepared coating solution is coated on a support by using a coating apparatus such as a doctor blade, roll coater or knife coater and dried to form the photostimulable phosphor layer. After the above coating solution may be coated on a protective layer and dried, the photostimulable phosphor layer may be adhered to the support.

A thickness of the photostimulable phosphor layer of the radiographic image conversion panel varies depending on characteristics of the objective radiographic image conversion panel, the kind of the photostimulable phosphor and a mixing ratio of the binder to the photostimulable phosphor, and is preferably 10 to 1,000 μm, and more preferably 10 to 500 μm.

A phosphor sheet comprising the support having thereon the phosphor layer is cut to a given size. Any general means for cutting is applicable but a trimming cutter and a punching machine are desirable in terms of working efficiency and precision.

The phosphor sheet cut to a given size is generally sealed with a moisture-proofing protective film. Examples of a sealing method include a method in which the phosphor sheet is laminated between moisture-proofing protective films and peripheral portions thereof are heat-sealed by an impulse sealer and a laminating method in which the phosphor sheet is pressed and heated between two heated rollers. In the heat-sealing method using an impulse sealer, heat-sealing is preferably conducted under a reduced pressure environment, in terms of preventing displacement of the phosphor sheet in the moisture-proofing protective film or removing atmospheric moisture.

### EXAMPLES

The present invention is described in detail below by referring to Examples.

Unless otherwise noted, “%” in Example indicates “% by mass”.

(Production of Phosphor P1 (BaFI))

To synthesize a precursor of tabular europium activated barium fluoroiodide photostimulable phosphor, 2500 ml of an aqueous BaI₂ solution (4.0 mol/l) and 26.5 ml of an aqueous EuI₃ solution (0.2 mol/l) were charged into a reaction vessel. Reaction mother liquor in the reaction vessel was maintained at 83° C. with stirring. Then, 322 ml of an aqueous ammonium fluoride solution (8 mol/l) was added to the reaction mother liquor using a roller pump to form a precipitate. After completing addition, heating was further continued for 2 hrs. with stirring to ripen the precipitate.

Then the precipitates were filtered, washed with methanol and dried under evacuation to obtain crystals of europium activated barium fluoroiodide. To prevent deformation of phosphor particles due to sintering during calcination and the change of particle size distribution due to fusing of particles, alumina ultrafine powder was added thereto in an amount of 1%, with sufficiently stirring by a mixer to cause the alumina powder to adhere uniformly to the surface of the crystals.

A mixture of europium activated barium fluoroiodide crystalline powder and alumina ultrafine particles was charged into a quartz core tube with a volume of 10 liters of a batch type rotary kiln. A mixed gas of nitrogen/hydrogen (99/1% by volume) was flowed at a flow rate of 10 l/min. for a period of 20 min. to replace an atmosphere. After sufficiently replacing an atmosphere in the core, the flow rate of the mixed gas of nitrogen/hydrogen (99/1% by volume) was decreased to 2 l/min. and the temperature was raised to 820° C. at a temperature increasing rate of 10° C./min. with rotating the core tube at a rate of 2 rpm.

After the sample temperature reached 820° C., a nitrogen/hydrogen/oxygen (98.4/1/0.6% by volume) mixed gas was flowed at a flow rate of 10 l/min. for 20 min. with maintaining a temperature at 820° C. to replace an atmosphere. Thereafter, the flow rate of the nitrogen/hydrogen/oxygen (98.4/1/0.6% by volume) mixed gas was decreased to 2 l/min. and the atmosphere was maintained further for 20 min.

Then, a nitrogen/hydrogen (99/1% by volume) mixed gas was flowed at a flow rate of 10 l/min. for 20 min. to replace an atmosphere. After sufficiently replacing the atmosphere in the core, the flow rate of the nitrogen/hydrogen (99/1% by volume) mixed gas was decreased to 2 l/min. and the atmosphere was maintained further for 60 min.

Thereafter, the atmosphere was cooled to 25° C. at a temperature decreasing rate of 10° C./min. with maintaining the flow rate of the nitrogen/hydrogen (99/1% by volume) mixed gas to 2 l/min. and then, replaced by the air to obtain a prepared oxygen-doped europium activated barium fluoroiodide photostimulable phosphor particle P1.

<Production of Phosphor P2 (BaFBr)>

175.3 g of BaF₂ powder, 391.1 g of BaBr₂ powder and 0.418 g of EuF₃ powder were each weighed, and were ground and mixed for 10 min. in an automatic mortar. The mixture was charged into a quartz core tube with a core volume of 10 liters of a batch type rotary kiln. A nitrogen/hydrogen (99/1% by volume) mixed gas was flowed at a flow rate of 10 l/min. for a period of 20 min. to replace an atmosphere. After sufficiently replacing an atmosphere in the core, the flow rate of the nitrogen/hydrogen (99/1% by volume) mixed gas was decreased to 2 l/min. and the temperature was raised to 820° C. at a temperature increasing rate of 10° C./min. with rotating the core tube at a rate of 2 rpm. After maintaining a temperature at 820° C. for 2 hrs., the atmosphere was cooled to a room temperature at a temperature decreasing rate of 10° C./min. to obtain a prepared phosphor particle P2.

<Surface Treatment of Phosphor>

Next, the obtained phosphor particles were subjected to surface treatment employing the kind and the amount used of the fluorine-containing compound as shown in Table 1. The surface treatment with the fluorine-containing compound was performed by dispersing 300 g of ground phosphor particles in 150 ml of a mixed solvent (prepared by Sumitomo 3M LTD.) comprising methylperfluoroisobutylether and methylperfluorobutylether with stirring by use of a Henschel mixer and dropwise adding thereto the fluorine polymer-containing compound as shown in Table 1 with stirring.

<Production of Radiographic Image Conversion Panel>

As materials for forming a phosphor layer, the thus prepared phosphor of europium activated barium fluoroiodide of 427 g, a polyurethane resin (Desmorack 4125, trade name, produced by Sumitomo-Bayer Urethane Co.) of 15.8 g and a bisphenol A-type epoxy resin of 2.0 g were added into a mixed solvent of methyl ethyl ketone and toluene (1:1) and dispersed by a propeller mixer to prepare a coating solution of a phosphor layer with a viscosity of 25 to 30 Pa·s.

The coating solution was coated on a subbed polyethylene terephthalate film by using a doctor blade and then dried at 100° C. for 15 min. and a phosphor layer with 230 μm in thickness was formed. The coated sample was cut into a square of 10 cm×10 cm to prepare radiographic image conversion panel samples 1 to 10 (panel samples 1 to 10).

Each sample was evaluated on moisture resistance and sensitivity (luminance) as follows. The results thereof are shown in Table 1.

<<Moisture Resistance>>

Prepared panel samples were allowed to stand for 2 days under environment of 30° C. and 80% RH (relative humidity) and thereafter, initial sensitivity and sensitivity after deterioration were calculated. The values in the Table each indicate an average of ten samples for each panel sample. As a difference between the initial sensitivity and the sensitivity after deterioration is smaller, moisture resistance is more excellent.

Sensitivity was measured in such a manner that radiographic image conversion panel samples were each exposed to X rays at a tube voltage of 80 kVp and then excited by scanning with He-Ne laser (633 nm), in which photostimulated light emitted from the photostimulable phosphor layer was detected by a photoreceptor (a photoelectron multiplier having spectral sensitivity of S-5) to measure its intensity.

The initial sensitivity and the sensitivity after deterioration each was represented by a relative value, based on the intensity of the panel (Panel Sample 10) being 1, in which phosphor particles P2 were not surface treated.

TABLE 1

| | | Amount of F | | | |
|---|---|---|---|---|---|
| | | (% by mass of fluorine- | | | |
| | Kind | containing compound | | Sensitivity | |
| Panel Sample | of F (monomer of fluorine-containing polymer) | based on phosphor) | Initial Sensitivity | after Deterioration | Phosphor Used |
| 1 | 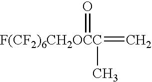 | 0.1 | 1.39 | 1.34 | P₁ |
| 2 | 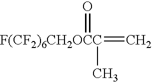 | 0.2 | 1.47 | 1.44 | P₁ |
| 3 | 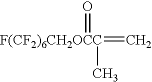 | 20 | 1.54 | 1.50 | P₁ |
| 4 | 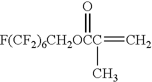 | 40 | 0.98 | 0.95 | P₁ |
| 5 | 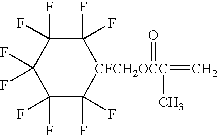 | 1 | 1.49 | 1.43 | P₂ |
| 6 | 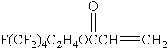 | 1 | 1.50 | 1.46 | P₁ |
| 7 | 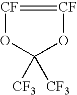 | 1 | 1.47 | 1.40 | P₂ |
| 8 | 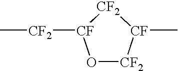 | 1 | 1.41 | 1.37 | P₁ |
| 9 | — | 0 | 1.28 | 0.12 | P₁ |
| 10 | — | 0 | 1.00 | 0.08 | P₂ |

As can be seen from Table 1, it was proved that the panel samples 1 to 8 prepared by using the photostimulable phosphor particles, which were surface treated with a fluorine-containing compound, were scarcely lowered in the sensitivity after deterioration as compared with the initial sensitivity. On the other hand, it was proved that the panel samples 9 and 10 prepared by using the phosphor particles, which were not surface treated, were largely lowered in the sensitivity after deterioration as compared with the initial sensitivity.

Thus, as is verified in Examples, according to the photostimulable phosphor and the method for producing the photostimulable phosphor by the present invention, a radiographic image conversion panel exhibiting little deterioration in sensitivity due to moisture absorption can be obtained.

In the above, the Examples of the present invention are explained. However, it is needless to say that the present invention is not limited to such Examples, but various modifications are possible in a range within the scope of the present invention.

According to the photostimulable phosphor and the method for producing the photostimulable phosphor by the present invention, the radiographic image conversion panel exhibits little deterioration in performance due to moisture absorption, is usable in a viable state over a long period of time and has excellent effects on image properties.

The entire disclosure of Japanese Patent Application Publication No. 2003-77668 filed on Mar. 20, 2003, including specification, claims, drawings and summary are incorporated herein by reference in its entirety.

What is claimed is:

1. A method for producing a photostimulable phosphor represented by a following General Formula (1), comprising: subjecting phosphor particles in the photostimulable phosphor to a surface treatment by using a fluorine-containing compound after calcining the phosphor particles:
(Ba₁₋ₓM¹)FBryI_{1-y}X:aM², bLn, cO General Formula (1)
wherein M¹ is at least one alkaline earth metal atom selected from Mg, Ca, Sr, Zn and Cd; M² is at least one alkaline metal atom selected from Li, Na, K, Rb and Cs; X is at least one halogen atom selected from Cl, Br and I; Ln is at least one rare earth atom selected from Ce, Pr, Sm, Eu, Gd, Tb, Tm, Dy, Ho, Nd, Er and Yb; and x, y, a, b and c are numbers within the range of 0≦x≦0.3, 0≦y≦0.3, 0≦a≦0.05, 0<b≦0.2 and 0<c≦0.1, respectively.

2. A method for producing a photostimulable phosphor represented by a following General Formula (1) in a liquid phase process, comprising: subjecting phosphor particles in the photostimulable phosphor to a surface treatment with a fluorine-containing compound after calcining the phosphor particles:
(Ba₁₋ₓM¹)FBryI_{1-y}X:aM², bLn, cO General Formula (1)
wherein M¹ is at least one alkaline earth metal atom selected from Mg, Ca, Sr, Zn and Cd; M² is at least one alkaline metal atom selected from Li, Na, K, Rb and Cs; X is at least one halogen atom selected from Cl, Br and I; Ln is at least one rare earth atom selected from Ce, Pr, Sm, Eu, Gd, Tb, Tm, Dy, Ho, Nd, Er and Yb; and x, y, a, b and c are numbers within the range of 0≦x≦0.3, 0≦y≦0.3, 0≦a≦0.05, 0<b≦0.2 and 0<c≦0.1, respectively.

3. The method of claim 1, wherein the fluorine-containing compound is obtained from a coating composition prepared by dissolving a fluorine-containing polymer with a fluorinated solvent.

4. The method of claim 1, wherein the amount of the fluorine-containing compound is from 0.2 to 20% by mass based on the photostimulable phosphor.

5. A photostimulable phosphor produced by subjecting phosphor particles in the photostimulable phosphor represented by a following General Formula (1) to a surface treatment by using a fluorine-containing compound after calcining the phosphor particles:
(Ba₁₋ₓM¹)FBryI_{1-y}X:aM², bLn, cO General Formula (1)
wherein M¹ is at least one alkaline earth metal atom selected from Mg, Ca, Sr, Zn and Cd; M² is at least one alkaline metal atom selected from Li, Na, K, Rb and Cs; X is at least one halogen atom selected from Cl, Br and I; Ln is at least one rare earth atom selected from Ce, Pr, Sm, Eu, Gd, Tb, Tm, Dy, Ho, Nd, Er and Yb; and x, y, a, b and c are numbers within the range of 0≦x≦0.3, 0≦y≦0.3, 0≦a≦0.05, 0<b≦0.2 and 0<c≦0.1, respectively.

6. The photostimulable phosphor of claim 5, wherein the fluorine-containing compound is obtained from a coating composition prepared by dissolving a fluorine-containing polymer with a fluorinated solvent.

7. The photostimulable phosphor of claim 5, wherein the amount of the fluorine-containing compound is from 0.2 to 20% by mass based on the photostimulable phosphor.
